(19) United States
(12) Patent Application Publication
(10) Pub. No.: US 2026/0030479 A1
(43) Pub. Date: Jan. 29, 2026

(54) SYSTEMS AND METHODS FOR TRAINING GENERATIVE MACHINE LEARNING MODELS

(71) Applicant: NEC Corporation Of America, Herzlia (IL)

(72) Inventors: Tsvi LEV, Tel-Aviv (IL); Yaacov HOCH, Ramat-Gan (IL)

(73) Assignee: NEC Corporation Of America, Herzlia (IL)

(21) Appl. No.: 18/786,735

(22) Filed: Jul. 29, 2024

(51) Int. Cl. G06N 3/045

(52) U.S. Cl. CPC G06N 3/045

(57) ABSTRACT

There is provided a computer implemented method of training a generative model, comprising: clustering training data elements each associated with an indication of a creation entity of creation entities, into clusters, each cluster including training data elements associated with one creation entity of the creation entities, generating training dataset by accessing training data elements from a sub-set of the clusters, each training dataset excluding at least one cluster of the clusters associated with at least creation entity, and training generative models on the training datasets, wherein each trained generative model of trained generative models is trained on training data elements that exclude at least one creation entity, wherein a target data element generated by a certain trained generative model in response to an input prompt excludes influence of the excluded at least one creation entity.

### BACKGROUND

The present invention, in some embodiments thereof, relates to generative models and, more specifically, but not exclusively, to systems and methods for training generative models.

A generative model is a type of machine learning model that is trained to generate new data samples that resemble a given dataset. These models learn the underlying patterns and structures in the training data and use this knowledge to create new, similar instances. Generative models can be used for various applications, including image synthesis, text generation, music composition, and data augmentation. Training a generative model involves feeding it large amounts of data so it can learn to produce new, similar data.

### SUMMARY

According to a first aspect, a computer implemented method of training a generative model, comprises: clustering a plurality of training data elements each associated with an indication of a creation entity of a plurality of creation entities, into a plurality of clusters, each cluster including training data elements associated with one creation entity of the plurality of creation entities, generating a plurality of training dataset by accessing training data elements from a sub-set of the plurality of clusters, each training dataset excluding at least one cluster of the plurality of clusters associated with at least creation entity, and training a plurality of generative models on the plurality of training datasets, wherein each trained generative model of a plurality of trained generative models is trained on training data elements that exclude at least one creation entity, wherein a target data element generated by a certain trained generative model in response to an input prompt excludes influence of the excluded at least one creation entity.

According to a second aspect, a computer implemented method for designating a generative model for inference, comprises: selecting a certain creation entity of a plurality of creation entities, selecting a first trained generative model trained on a first training dataset that excludes training data elements associated with the certain creation entity, selecting a second trained generative model trained on a second training dataset that includes training data elements associated with the certain creation entity, feeding an input prompt into the first trained generative model to obtain a first target data element, feeding the input prompt into the second trained generative model to obtain a second target data element, performing a statistical comparison between the first target data element and the second target data element for determining statistical similarity, and in response to the statistical comparison showing non-statistical similarity indicating statistically significant differences between the first target data element and the second target data element, blocking or removing the second trained generative model from being accessed for inference.

According to a third aspect, a computer implemented method for designating a generative model for inference, comprises: selecting a certain creation entity of a plurality of creation entities, identifying at least one first trained generative model trained on a first training dataset that included data elements associated with the certain creation entity, blocking or removing the identified at least one first trained generative model from being accessed for inference, identifying at least one second trained generative model trained on a second training dataset that excluded data elements associated with the certain creation entity, and providing the at least one second trained generative model for inference.

In a further implementation form of the first, second, and third aspects, the plurality of training dataset are created by generating combinations of different sub-sets of the plurality of clusters, each sub-set excluding at least one cluster of the plurality of clusters.

In a further implementation form of the first, second, and third aspects, further comprising: selecting a certain creation entity of the plurality of creation entities, selecting a first trained generative model trained on a first training dataset that excludes training data elements associated with the certain creation entity, selecting a second trained generative model trained on a second training dataset that includes training data elements associated with the certain creation entity, feeding an input prompt into the first trained generative model to obtain a first target data element, feeding the input prompt into the second trained generative model to obtain a second target data element, and performing a statistical comparison between the first target data element and the second target data element for determining statistical similarity.

In a further implementation form of the first, second, and third aspects, the statistical comparison is performed by extracting a first set of features from the first target data element and a second set of features from the second target data element, analyzing the first set with respect to the second set for determining the statistical similarity.

In a further implementation form of the first, second, and third aspects, the statistical comparison is performed by feeding the first target data element and the second target data element into a comparator model that generates an indication of whether the first target data element and the second target data element are statistically similar or statistically different.

In a further implementation form of the first, second, and third aspects, the comparator model is trained on a training dataset of pairs of data elements, each pair labelled with a ground truth indicating whether the pair is statistically similar or statistically different.

In a further implementation form of the first, second, and third aspects, further comprising, in response to the statistical comparison showing non-statistical similarity indicating statistically significant differences between the first target data element and the second target data element, blocking or removing the second trained generative model from being accessed for inference.

In a further implementation form of the first, second, and third aspects, further comprising providing the first trained generative model for being accessed for inference.

In a further implementation form of the first, second, and third aspects, the statistical comparison is performed by computing a first vector representation of the first target data element, and a second vector representation of the second target data element, and determining whether a Euclidean distance between the first vector and the second vector is below a threshold indicating statistical similarity or above the threshold indicating statistical difference.

In a further implementation form of the first, second, and third aspects, further comprising iterating the feeding for a plurality of input prompts to generate a plurality of first target data elements and a plurality of second target data elements, clustering the plurality of first target data elements to create at least one first cluster, clustering the plurality of second target data elements to create at least one second cluster, and computing a distance between at least one first centroid of at least one first cluster and at least one second centroid of the at least one second cluster, and determining whether a Euclidean distance between the at least one first centroid and the at least one second centroid is below a threshold indicating statistical similarity or above the threshold indicating statistical difference.

In a further implementation form of the first, second, and third aspects, further comprising: iterating the feeding for a plurality of input prompts to generate a plurality of pairs, each pair including a respective first target data element and respective second target data element, iterating the statistical comparison for each pair to obtain a sub-statistical metric, and analyzing a plurality of the sub-statistical metrics to obtain a global statistical metric for determining the statistical similarity between the plurality of pairs.

In a further implementation form of the first, second, and third aspects, further comprising: selecting a certain creation entity of the plurality of creation entities, identifying at least one first trained generative model trained on a first training dataset that included data elements associated with the certain creation entity, blocking or removing the identified at least one first trained generative model from being accessed for inference, identifying at least one second trained generative model trained on a second training dataset that excluded data elements associated with the certain creation entity, and providing the at least one second trained generative model for inference.

In a further implementation form of the first, second, and third aspects, the training data elements and target data elements are selected from: image, video, text, spoke audio, and music.

In a further implementation form of the first, second, and third aspects, the creation entities are selected from: artist, actor, media company, studio, and other generative model.

In a further implementation form of the first, second, and third aspects, further comprising: selecting a creation entity of the plurality of creation entities, selecting a trained generative model trained on a training dataset that includes training data elements associated with the certain creation entity, feeding at least one input prompt into the trained generative model to obtain at least one target data element, and performing a statistical comparison between the at least one target data element and at least one of the training data elements associated with the certain creation entity used to train the selected generative model.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE SEVERAL VIEWS OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a block diagram of components of a system for training generative models where each generative model is trained on a training dataset excluding one or more creation entities, in accordance with some embodiments of the present invention;

FIG. 2 is a flowchart of a method of training generative models where each generative model is trained on a training dataset excluding one or more creation entities, in accordance with some embodiments of the present invention;

FIG. 3 is a flowchart of a method of determining whether data elements created by a certain creation entity significantly contributed to a target data element generated by a generative model, in accordance with some embodiments of the present invention; and

FIG. 4 is a flowchart of a method of blocking and/or removing a generative model trained on data elements created by a certain creation entity, in accordance with some embodiments of the present invention.

### DETAILED DESCRIPTION

The present invention, in some embodiments thereof, relates to generative models and, more specifically, but not exclusively, to systems and methods for training generative models.

An aspect of some embodiments of the present invention relates to systems, methods, computing devices, and/or code instructions for training generative models. Training data elements are clustered into multiple clusters. Each training element is associated (e.g., created by, owned by, assigned to) with an indication of a creation entity selected from multiple different creation entities, for example, a creation artist, including a certain entity such as a certain actor, a creation studio, a media company, and the like. Each cluster includes training data elements associated with one creation entity. Multiple different training dataset are generated by accessing training data elements from a different sub-set of clusters representing a different combination of selected clusters. A target data element generated by a certain trained generative model in response to an input prompt excludes influence of the excluded creation entity. For example, an image generated by the first generative model excludes influence by images captured by the first photographer.

Optionally, a certain creation entity is selected from the available creation entities that created the data elements of the different training datasets. A first trained generative model trained on a first training dataset that excludes the certain creation entity, is selected. A second trained generative model trained on a second training dataset that includes the certain creation entity, is selected. An input prompt is fed into the first trained generative model to obtain a first target data element. The same input prompt is fed into the second trained generative model to obtain a second target data element. A statistical comparison is performed between the first target data element and the second target data element for determining statistical similarity. Statistical similarity indicates that the data elements created by the certain creation entity, used to train the second generative model, do not significantly contribute to generation of the second target data element generated by second generative model. When statistical dis-similarity, i.e., statistically significant differences between the first target data element and the second target data element, is identified, the second generative model may be removed and/or access to the second generative model for inference may be blocked. The statistical dis-similarity may indicate that the training data elements created by the certain creation entity significantly contribute to the generation of the second target data element.

Alternatively or additionally, in response to the selection of the certain creation entity, a trained generative model trained on a training dataset that included data elements associated with the certain creation entity is removed and/or access to the trained generative model for inference is blocked. A different trained generative model training on a different training dataset that excluded data elements associated with the certain creation entity is selected for use.

As used herein, the term unauthorized data element refers to data elements associated with a certain creation entity for which permission to be used in training was not obtained.

At least one embodiment described herein addresses the technical problem of use of unauthorized training data elements for training generative models. At least one embodiment described herein improves the technology of training generative models, by providing approaches for using of unauthorized training data elements for training generative models. At least one embodiment described herein improves upon prior approaches of training generative models using unauthorized training data elements.

Data elements created by a certain creation entity, used for training a generative model, may be unauthorized for use, in that no permission was granted by their creation entity for their use in training the generative model. For example, a certain artist that created a set of images, which were used for training a generative model that creates images, may object to the use of the set of images for training the generative model. In some cases, the artist may sue the creations (e.g., trainers) of the generative model if the data elements were used for training the generative model without proper agreements.

Managing the generative model that was trained with unauthorized data elements is technically challenging using prior approaches. First, it is difficult to determine that even if unauthorized training data elements were used for training the generative model, whether those unauthorized training data elements significantly contributed to the output of the generative model. An image generated by the generative model trained on unauthorized training data elements may not visually resemble at all any of the unauthorized trained data elements. For example, for a generative model trained on thousands of images, even if a small number of training data elements are unauthorized, it is unlikely that the unauthorized training data elements significantly contributed to the outcome of the generative model. Second, if the training data elements used were unauthorized, it is computationally inefficient to remove their impact from the generative model. For example, re-training the generative model with the same data set from which the unauthorized data elements were removed is computationally inefficient, due to the amount of processing time and/or amount of processing resources required for retraining.

At least one embodiment described herein addresses the aforementioned technical problem and/or improves the aforementioned technology and/or improves upon the aforementioned prior approaches, by training multiple generative models on different training sets, where each training dataset excludes training data elements associated with a different respective creation entity. There may be different combinations of training datasets, where at least one training dataset excludes training elements from a certain creation entity. In response to an allegation of use of unauthorized training elements for a creation entity, a generative model that was trained on a training dataset that excluded data elements associated with the creation entity may be identified and used. Other generative models trained on training datasets that included data elements associated with the certain creation entity may be blocked and/or removed from being accessed for inference (i.e., generating outputs). This may enable quickly providing uninterrupted service to users while the claim for use of unauthorized data elements is being investigated. Alternatively, in response to the allegation, the contribution of the unauthorized data elements to the output generated by the generative model trained on the unauthorized data elements may be evaluated. The generative model may remain in use when the unauthorized data elements do not materially contribute to the output. The generative model may be blocked or removed when the unauthorized data elements contributed significantly to the output.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

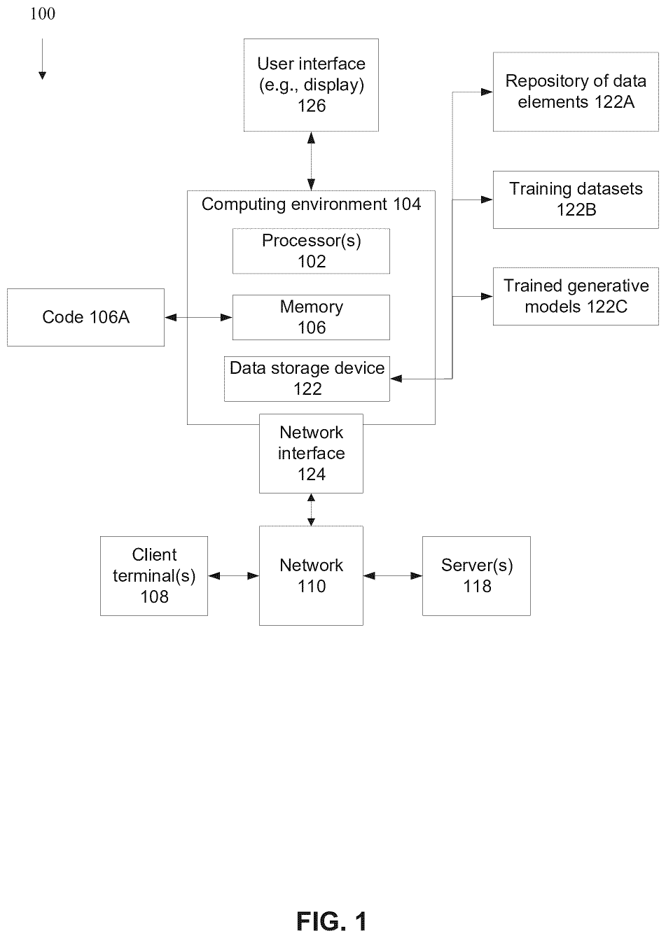

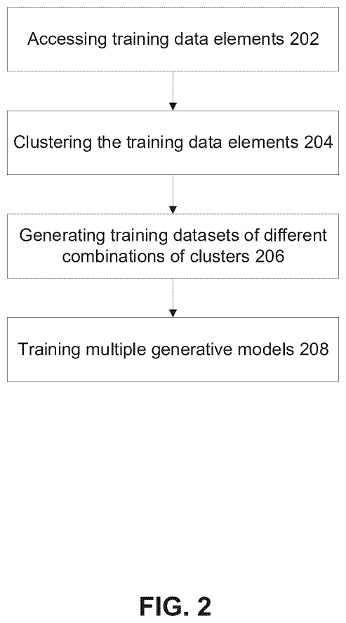

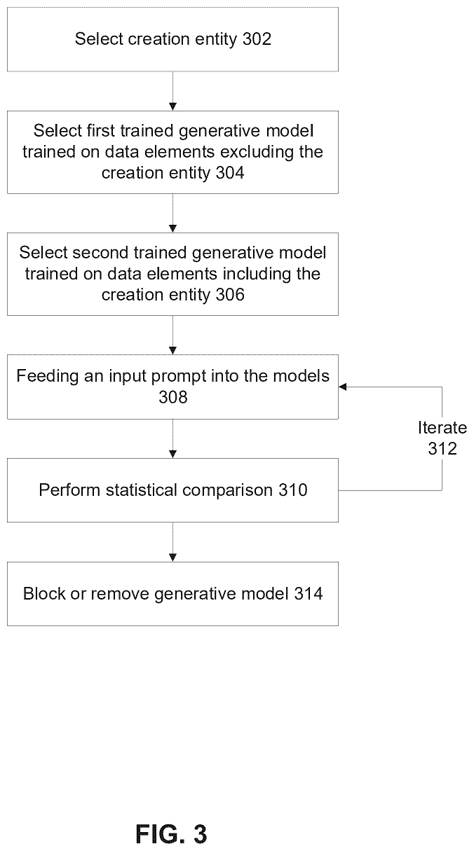

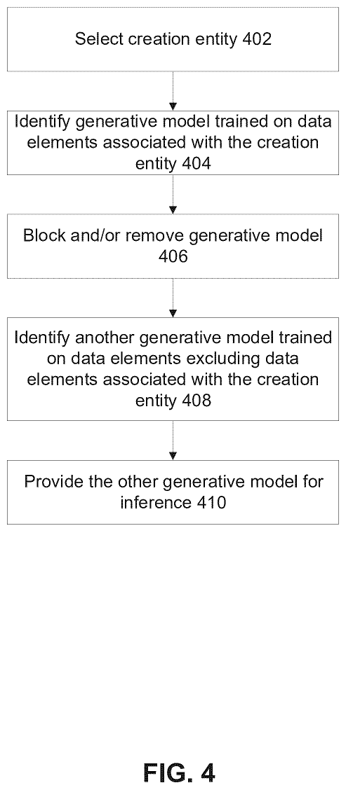

Reference is now made to FIG. 1, which is a block diagram of components of a system 100 for training generative models where each generative model is trained on a training dataset excluding one or more creation entities, in accordance with some embodiments of the present invention. Reference is also made to FIG. 2, which is a flowchart of a method of training generative models where each generative model is trained on a training dataset excluding one or more creation entities, in accordance with some embodiments of the present invention. Reference is also made to FIG. 3, which is a flowchart of a method of determining whether data elements created by a certain creation entity significantly contributed to a target data element generated by a generative model, in accordance with some embodiments of the present invention. Reference is also made to FIG. 4, which is a flowchart of a method of blocking and/or removing a generative model trained on data elements created by a certain creation entity, in accordance with some embodiments of the present invention.

System 100 may implement the acts of the method described with reference to FIGS. 2-4, by processor(s) 102 of a computing environment 104 executing code instructions stored in a memory 106 (also referred to as a program store).

Computing environment 104 may be implemented as, for example one or more and/or combination of: a group of connected devices, a client terminal, a server, a virtual server, a computing cloud, a virtual machine, a desktop computer, a thin client, a network node, and/or a mobile device (e.g., a Smartphone, a Tablet computer, a laptop computer, a wearable computer, glasses computer, and a watch computer).

Computing environment 104 creates different training datasets 122B using different combinations that exclude data elements (e.g., stored in a repository 122B) associated with different creation entities. Multiple generative models 122C are trained on the different training datasets 122B, as described herein. Computing environment 104 may block and/or remove specific generative models trained on training datasets that include unauthorized data element. Computing environment 104 may compute an objective measure indicating whether unauthorized training data elements significantly contribute towards an output of a certain generative model.

Multiple architectures of system 100 based on computing environment 104 may be implemented. For example:
Computing environment 104 executing stored code instructions 106A, may be implemented as one or more servers (e.g., network server, web server, a computing cloud, a virtual server) that provides centralized services for generating multiple generative models on different training datasets, for blocking and/or removing specific generative models trained on datasets that include unauthorized data elements, and/or for determining whether unauthorized data elements used to train a certain generative model significantly contribute to the output of the certain generative model, as described herein. Services may be provided, for example, to one or more client terminals 108 over network 110, and/or to one or more server(s) 118 over network 110. Services may be provided by computing environment 104 to client terminals 108 and/or server(s) 118, for example, as software as a service (Saas), a software interface (e.g., application programming interface (API), software development kit (SDK)), an application for local download to the client terminal(s) 108 and/or server(s) 118, an add-on to a web browser running on client terminal(s) 108 and/or server(s) 118, and/or providing functions using a remote access session to the client terminals 108 and/or server(s) 118, such as through a web browser executed by client terminal 108 and/or server(s) 118 accessing a web sited hosted by computing environment 104. For example, computing environment 104 generates multiple generative models 122C on different training datasets 122B. Client terminals 108 may access the generative models for inference, for example, users may provide prompts to the generative models, and obtain target data elements generated by the generative models. In response to an allegation that unauthorized data elements were used. Computing environment 104 may provide client terminals 108 with access to generative model(s) not trained on the unauthorized data elements, and/or may block or remove generative model(s) trained on the authorized data elements.
Computing environment 104 may be implemented as a standalone device (e.g., kiosk, client terminal, smartphone) that include locally stored code instructions 106A that implements one or more of the acts described with reference to FIGS. 2-4, for locally generating multiple generative models on different training datasets, for blocking and/or removing specific generative models trained on datasets that include unauthorized data elements, and/or for determining whether unauthorized data elements used to train a certain generative model significantly contribute to the output of the certain generative model, as described herein.

The locally stored code instructions 106A may be obtained from a server, for example, by downloading the code over the network, and/or loading the code from a portable storage device, such as by installing an app on a smartphone of a user. In an example, computing environment 104 may be implemented as a kiosk, where users provide prompts to create images by the generative models, and the created images are printed. In response to an allegation of use of unauthorized data elements, generative models trained on the unauthorized data elements may be locally blocked, and other generative models trained on training datasets that exclude the unauthorized data elements are provided.

Processor(s) 102 of computing environment 104 may be hardware processors, which may be implemented, for example, as a central processing unit(s) (CPU), a graphics processing unit(s) (GPU), field programmable gate array(s) (FPGA), digital signal processor(s) (DSP), and application specific integrated circuit(s) (ASIC). Processor(s) 102 may include a single processor, or multiple processors (homogenous or heterogeneous) arranged for parallel processing, as clusters and/or as one or more multi core processing devices.

Memory 106 stores code instructions executable by hardware processor(s) 102, for example, a random access memory (RAM), read-only memory (ROM), and/or a storage device, for example, non-volatile memory, magnetic media, semiconductor memory devices, hard drive, removable storage, and optical media (e.g., DVD, CD-ROM). Memory 106 stores code 106A that implements one or more features and/or acts of the method described with reference to FIGS. 2-4 when executed by hardware processor(s) 102.

Computing environment 104 may include a data storage device 122 for storing data, for example, repository 122A set to store data elements of different creation entities, training datasets 122B that include data elements of different combinations of creation entities, and generative models 122C trained on the different training datasets 122C, as described herein. Data storage device 122 may be implemented as, for example, a memory, a local hard-drive, virtual storage, a removable storage unit, an optical disk, a storage device, and/or as a remote server and/or computing cloud (e.g., accessed using a network connection).

Network 110 may be implemented as, for example, the internet, a local area network, a virtual network, a wireless network, a cellular network, a local bus, a point to point link (e.g., wired), and/or combinations of the aforementioned.

Computing environment 104 may include a network interface 124 for connecting to network 110, for example, one or more of, a network interface card, a wireless interface to connect to a wireless network, a physical interface for connecting to a cable for network connectivity, a virtual interface implemented in software, network communication software providing higher layers of network connectivity, and/or other implementations.

Computing environment 104 and/or client terminal(s) 108 include and/or are in communication with one or more user interfaces 126. Exemplary user interfaces 126 include, for example, one or more of, a touchscreen, a display, gesture activation devices, a keyboard, a mouse, and voice activated software using speakers and microphone.

Referring now back to FIG. 2, at 202, multiple training data elements are accessed.

Each training element is associated with an indication of a creation entity. The creation entity may have created the training element, owns the training element, has rights assigned to the training element, and the like. Examples of creation elements include artists, actors, media companies, studios, and another generative model.

Examples of training elements include image, video, text, spoke audio, and music.

At 204, the training data elements may be clustered into multiple clusters. The clustering may be according to respective creation entities associated with the training data elements. Each cluster includes training data elements associated with one creation entity of multiple creation entities.

The number of clusters may correspond to the number of unique creation entities of all of the training data elements. Each cluster may include data elements associated with a single unique creation entity. Alternatively, the number of clusters may correspond to selected combinations of unique creation entities of the training data elements. For example, each cluster may include data elements associated with two unique creation entities. The number of clusters and/or definition of which data elements are included in the cluster may be based on, for example, simplicity, heuristic approaches, and/or availability of processing resources (e.g., processor, memory) for training multiple generative models.

The clustering may be virtually implemented as, for example, a mapping table where each entry in the mapping table corresponds to a certain creation entity of multiple candidate creation entities, and an indication and/or pointer to the training data elements associated with the respective creation entity.

In another example, the clustering may be implemented by creating different “buckets”, a respective bucket for each creation entity. The training data elements are deposited or mapped to corresponding buckets.

At 206, multiple training dataset are generated by accessing training data elements from sub-sets of the clusters. Training datasets are created such that each respective training dataset excludes training data elements associated with at least one creation entity and includes training data elements associated with one or more other creation data elements. Each training dataset excludes at least one cluster associated with at least creation entity and includes at least one other cluster associated with at least one other creation entity.

In a simple case, each training dataset includes training data elements of a single cluster. The number of training datasets may correspond to the number of clusters. In more complex cases, the training datasets may be created by generating combinations of different sub-sets of the clusters. Each sub-set of clusters excluding at least one cluster of the generated clusters and includes at least one other cluster of the generated clusters. Each cluster may be included in at least one training dataset. The number of training datasets may be less than the number of clusters. For example, where there are 4 clusters, and each training dataset includes two clusters, the training datasets may be as follows: first training dataset based on clusters 1 and 2, second training dataset based on clusters 3 and 4. The number of training datasets is 2, in comparison to 4 when each training dataset includes a single cluster. Such implementation may be selected, for example, to reduce the number of training datasets for improve computational efficiency of a computer training generative models. Since training each generative model requires significant processing time and/or utilization of processing resources (e.g., processor(s)) and/or memory, reducing the total number of training datasets improves the computational efficiency. It is noted that the tradeoff is that if a certain creation entity objects to their data elements being used in training the generative model, then the other generative model that is selected to be used also excludes being trained on additional data elements from another creation entity.

At 208, multiple generative models are trained on the training datasets. The generative models are provided. The generative models may be selected and/or removed and/or blocked and/or evaluated, for example, according to more creation entities raising objections to the use of their data elements in training the generative models, for example, as described with reference to FIG. 3 and/or FIG. 4.

Each trained generative model is trained on a training dataset of training data elements that exclude data elements associated with at least one creation entity and includes other data elements associated with at least one other creation entity.

A target data element generated by a certain trained generative model (in response to an input prompt) excludes influence of data elements associated with the excluded creation entity.

Optionally, one respective generative model is trained on a respective training dataset.

In a simple example, data elements are images captured by different photographers. In the example, there are a total of 5 unique photographers that captured all of the available images. The photographers are numbered 1-5 for clarity. 5 cluster of images are created. Each cluster includes images created by a different photographer. Cluster 1 includes images created by photographer 1, cluster 2 includes images created by photographer 2, and the like. Training dataset are created, where each training dataset excludes at least one cluster associated with at least creation entity. A first training dataset includes clusters 2-5, which include images from photographers 2-5, and excludes images from cluster 1 of photographer 1. A second training dataset includes images from clusters 1 and 3-5, which include images of photographers 1 and 3-5, and excludes images from cluster 2 of photographer 2. A third training dataset includes images from clusters 1, 2, 4, and 5, which include images of photographers 1, 2, 4, 5, and excludes images from cluster 1 of photographer 3, and so on. First training dataset does not include any images created by photographer 1. Second training dataset does not include any images created by photographer 2. Third training dataset does not include any images created by photographer 3, and so on. Multiple generative models are trained on the training datasets. Each trained generative model is trained on training data elements that exclude at least one creation entity. For example, a first generative model is trained on the first training dataset, which excludes images from photographer 1. A second generative model is trained on the second training dataset, which excludes images from photographer 2. A third generative model is trained on the third training dataset, which excludes images from photographer 3, and so on.

Alternatively, one respective generative model is trained on a combination of two or more training datasets. Factors is selecting the number and/or combinations of training datasets are similar to the description above with respective to selecting the number and/or combinations of clusters.

Parameters for training of the multiple generative models may be the same and/or similar, with the exception of the data elements included in the training datasets. For example, the same learning rate, batch size, loss function, optimizer, and the like.

The architectures of the multiple generative models may be the same and/or similar. For example, same global architecture, same latent space dimension, same number of layers, same type of layers, and the like.

The generative models may be of different architectures, for example, generative adversarial networks (GANs), variational autoencoders (VAEs), autoregressive models, transformer-based models, and the like.

Referring now back to FIG. 3, at 302, a certain creation entity of multiple creation entities is selected and/or identified. The multiple creation entities may be associated with data elements used to train one or more generative models.

The creation entity may be selected, for example, due to an objection raised by the creation entity in using the data elements associated with the creation entity (e.g., created by, owned by) in training one or more generative models.

At 304, a first trained generative model trained on a first training dataset that excludes data elements associated with the certain creation entity is selected and/or accessed.

At 306, a second trained generative model trained on a second training dataset that includes data elements associated with the certain creation entity is selected and/or accessed.

At 308, an input prompt is fed into the first trained generative model to obtain a first target data element. The same input prompt is fed into the second trained generative model to obtain a second target data element.

At 310, a statistical comparison is performed for determining statistical similarity between the first target data element and the second target data element.

The statistical comparison may be a metric indicating how similar the first target element is to the second target element, and/or how different the first target element is to the second target element. The similarity may be in terms of the type of data element, for example, when the first and second target data elements are images, the statistical comparison may evaluate how visually similar are the two images are to each other. In another example, when the first and second target data elements are audio files, the statistical comparison may evaluate how similar are the two audio files to each other.

Statistical similarity may indicate that the data elements associated by the creation entity, used to train the second generative model, do not significantly contribute to generation of the second target data element generated by second generative model. Statistically significant differences between the first target data element and the second target data element are identified may indicate that the training data elements associated with the creation entity significantly contribute to the generation of the second target data element. For example, certain objects and/or certain poses and/or certain combinations of colors unique to the data elements associated with the creation entity (which may appear in the training elements associated with the creation entity) appear in the second target data element but do not appear in the first target data element.

Exemplary approaches for performing the statistical comparison include:
Extracting a first set of features from the first target data element and a second set of features from the second target data element. The first set of features is analyzed with respect to the second set of features for determining the statistical similarity. The sets of features may be, for example, vectors extracted from hidden layers of the respective generative models, hand-crafted features, and/or features extracted based on image processing approaches such as pixel intensity values, color distributions, edges, contours, corners, histogram of oriented gradients (HOG), Fourier transform, scale-invariant feature transformation (SIFT), speeded up robust features (SURF), geometrical shapes. The analysis may be performed, for example, by computing a correlation between the two sets of features, and comparing the correlation value to a threshold that separates between similar and different.
Feeding the first target data element and the second target data element into a comparator model that generates an indication of whether the first target data element and the second target data element are statistically similar or statistically different. The comparator model may generate a binary output, for example, similar or different. Alternatively or additionally, the comparator model may generate an indication of amount of similarity and/or amount of different. The comparator model may be trained on a training dataset of pairs of data elements, each pair labelled with a ground truth indicating whether the pair is statistically similar or statistically different. When the pairs are similar, similar regions and/or similar features may be marked.
Computing a first vector representation of the first target data element, and a second vector representation of the second target data element. Alternatively or additionally, vectors may be extracted from values of neurons in one or more hidden layers of the generative models. A Euclidean distance (or other measure) may be computed between the first vector and the second vector. A distance below a threshold may indicate statistical similarity. A distance above the threshold may indicate statistical differences.
In the case where similarities are found, a region of difference may be segmented and/or marked with a boundary box. In another example, differences in features may be visually indicates, for example, different geometrical shapes, contours, and/or edges may be color coded and/or bolded and/or marked with an arrow.

Alternatively or additionally, the statistical comparison is performed between the second target data element generated by the second generative model, and one or more of the training data elements used to train the second generative model which are associated with the certain creation entity. For example, to determine whether certain objects and/or certain poses and/or certain combinations of colors unique to the data elements associated with the creation entity used to train the second generative model appear in the second target data element.

Another the statistical comparison may be performed between the second target data element generated by the second generative model, and one or more of the training data elements used to train the second generative model which are associated with other certain creation entities. For example, to check the influence of the data elements associated with the other creation entities on the target data element in comparison to the influence of the data elements associated with the certain creation entity on the target data element.

At 312, one or more features described with reference to 308-310 may be iterated.

The iterations may be performed by feeding multiple input prompts to generate multiple first target data elements and multiple second target data elements. The multiple first and second data elements may be analyzed. For example, by clustering the first target data elements to create a first cluster(s), and clustering the second target data elements to create a second cluster(s). A distance between a first centroid of the first cluster(s) and a second centroid of the second cluster(s) may be computed. A Euclidean distance (or other measure) may be computed between the first centroid(s) and the second centroid(s). The Euclidean distance being is below a threshold may indicate statistical similarity or above the threshold may indicate statistical difference.

In another example, the iteration may be performed by feeding different input prompts into the first and second generative models to generate pairs of target data elements. Each pair includes a respective first target data element and respective second target data element. The statistical comparison is iterated for each pair to obtain a sub-statistical metric. Multiple sub-statistical metrics may be analyzed to obtain a global statistical metric for determining the statistical similarity between the pairs, for example, average, distribution comparison (e.g., t-test), and the like.

At 314, in response to the statistical comparison showing non-statistical similarity indicating likelihood of statistically significant differences between the first target data element and the second target data element, the second trained generative model may be blocked and/or moved from being accessed for inference (i.e., for generating target data elements in response to an input). The blocking and/or removing may be automatically performed. The blocking and/or removing may be performed while the allegations of the creation entity's use of unauthorized data elements are investigated.

Optionally, the first generative model(s), which are not trained on data elements associated with the creation entity, are provided for inference. The first generative model may be provided in place of the second generative model.

Referring now back to FIG. 4, at 402, a certain creation entity of multiple creation entities is selected and/or identified. The multiple creation entities may be associated with data elements used to train one or more generative models.

The creation entity may be selected, for example, due to an objection raised by the creation entity in using the data elements associated with the creation entity (e.g., created by, owned by) in training one or more generative models.

At 404, a trained generative model(s) trained on a training dataset that included data elements associated with the certain creation entity, is identified.

At 406, the identified generative model is blocking and/or removed from being accessed for inference.

At 408, another trained generative model(s) trained on a different training dataset that excluded data elements associated with the certain creation entity, is identified.

At 410, the other trained generative model(s) is provided for inference.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is expected that during the life of a patent maturing from this application many relevant generative model will be developed and the scope of the term generative model is intended to include all such new technologies a priori.

As used herein the term “about” refers to ±10%.

The terms “comprises”, “comprising”, “includes”, “including”, “having” and their conjugates mean “including but not limited to”. This term encompasses the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

It is the intent of the applicant(s) that all publications, patents and patent applications referred to in this specification are to be incorporated in their entirety by reference into the specification, as if each individual publication, patent or patent application was specifically and individually noted when referenced that it is to be incorporated herein by reference. In addition, citation or identification of any reference in this application shall not be construed as an admission that such reference is available as prior art to the present invention. To the extent that section headings are used, they should not be construed as necessarily limiting. In addition, any priority document(s) of this application is/are hereby incorporated herein by reference in its/their entirety.

What is claimed is:

1. A computer implemented method of training a generative model, comprising:
clustering a plurality of training data elements each associated with an indication of a creation entity of a plurality of creation entities, into a plurality of clusters, each cluster including training data elements associated with one creation entity of the plurality of creation entities;
generating a plurality of training dataset by accessing training data elements from a sub-set of the plurality of clusters, each training dataset excluding at least one cluster of the plurality of clusters associated with at least creation entity; and
training a plurality of generative models on the plurality of training datasets, wherein each trained generative model of a plurality of trained generative models is trained on training data elements that exclude at least one creation entity,
wherein a target data element generated by a certain trained generative model in response to an input prompt excludes influence of the excluded at least one creation entity.

2. The computer implemented method of claim 1, wherein the plurality of training dataset are created by generating combinations of different sub-sets of the plurality of clusters, each sub-set excluding at least one cluster of the plurality of clusters.

3. The computer implemented method of claim 1, further comprising:
selecting a certain creation entity of the plurality of creation entities;
selecting a first trained generative model trained on a first training dataset that excludes training data elements associated with the certain creation entity;
selecting a second trained generative model trained on a second training dataset that includes training data elements associated with the certain creation entity;
feeding an input prompt into the first trained generative model to obtain a first target data element;
feeding the input prompt into the second trained generative model to obtain a second target data element; and
performing a statistical comparison between the first target data element and the second target data element for determining statistical similarity.

4. The computer implemented method of claim 3, wherein the statistical comparison is performed by extracting a first set of features from the first target data element and a second set of features from the second target data element, analyzing the first set with respect to the second set for determining the statistical similarity.

5. The computer implemented method of claim 3, wherein the statistical comparison is performed by feeding the first target data element and the second target data element into a comparator model that generates an indication of whether the first target data element and the second target data element are statistically similar or statistically different.

6. The computer implemented method of claim 5, wherein the comparator model is trained on a training dataset of pairs of data elements, each pair labelled with a ground truth indicating whether the pair is statistically similar or statistically different.

7. The computer implemented method of claim 3, further comprising, in response to the statistical comparison showing non-statistical similarity indicating statistically significant differences between the first target data element and the second target data element, blocking or removing the second trained generative model from being accessed for inference.

8. The computer implemented method of claim 7, further comprising providing the first trained generative model for being accessed for inference.

9. The computer implemented method of claim 3, wherein the statistical comparison is performed by computing a first vector representation of the first target data element, and a second vector representation of the second target data element, and determining whether a Euclidean distance between the first vector and the second vector is below a threshold indicating statistical similarity or above the threshold indicating statistical difference.

10. The computer implemented method of claim 3, further comprising iterating the feeding for a plurality of input prompts to generate a plurality of first target data elements and a plurality of second target data elements, clustering the plurality of first target data elements to create at least one first cluster, clustering the plurality of second target data elements to create at least one second cluster, and computing a distance between at least one first centroid of at least one first cluster and at least one second centroid of the at least one second cluster, and determining whether a Euclidean distance between the at least one first centroid and the at least one second centroid is below a threshold indicating statistical similarity or above the threshold indicating statistical difference.

11. The computer implemented method of claim 3, further comprising:
iterating the feeding for a plurality of input prompts to generate a plurality of pairs, each pair including a respective first target data element and respective second target data element,
iterating the statistical comparison for each pair to obtain a sub-statistical metric; and
analyzing a plurality of the sub-statistical metrics to obtain a global statistical metric for determining the statistical similarity between the plurality of pairs.

12. The computer implemented method of claim 1, further comprising:
selecting a certain creation entity of the plurality of creation entities;
identifying at least one first trained generative model trained on a first training dataset that included data elements associated with the certain creation entity;
blocking or removing the identified at least one first trained generative model from being accessed for inference;
identifying at least one second trained generative model trained on a second training dataset that excluded data elements associated with the certain creation entity; and
providing the at least one second trained generative model for inference.

13. The computer implemented method of claim 1, wherein the training data elements and target data elements are selected from: image, video, text, spoke audio, and music.

14. The computer implemented method of claim 1, wherein the creation entities are selected from: artist, actor, media company, studio, other generative model.

15. The computer implemented method of claim 1, further comprising:
selecting a creation entity of the plurality of creation entities;
selecting a trained generative model trained on a training dataset that includes training data elements associated with the certain creation entity;
feeding at least one input prompt into the trained generative model to obtain at least one target data element; and
performing a statistical comparison between the at least one target data element and at least one of the training data elements associated with the certain creation entity used to train the selected generative model.

16. A computer implemented method for designating a generative model for inference, comprising:
selecting a certain creation entity of a plurality of creation entities;
selecting a first trained generative model trained on a first training dataset that excludes training data elements associated with the certain creation entity;
selecting a second trained generative model trained on a second training dataset that includes training data elements associated with the certain creation entity;
feeding an input prompt into the first trained generative model to obtain a first target data element;
feeding the input prompt into the second trained generative model to obtain a second target data element;
performing a statistical comparison between the first target data element and the second target data element for determining statistical similarity; and
in response to the statistical comparison showing non-statistical similarity indicating statistically significant differences between the first target data element and the second target data element, blocking or removing the second trained generative model from being accessed for inference.

17. A computer implemented method for designating a generative model for inference, comprising:
selecting a certain creation entity of a plurality of creation entities;
identifying at least one first trained generative model trained on a first training dataset that included data elements associated with the certain creation entity;
blocking or removing the identified at least one first trained generative model from being accessed for inference;
identifying at least one second trained generative model trained on a second training dataset that excluded data elements associated with the certain creation entity; and
providing the at least one second trained generative model for inference.
